(19) United States
(12) Patent Application Publication
(10) Pub. No.: US 2018/0317703 A1
(43) Pub. Date: Nov. 8, 2018

(54) BARBECUE SPIT WITH GRILL NETS

(71) Applicant: Araik Khachatrian, Kyiv (UA)

(72) Inventor: Araik Khachatrian, Kyiv (UA)

(21) Appl. No.: 15/750,202

(22) PCT Filed: Feb. 19, 2016
(86) PCT No.: PCT/IB2016/050891

§ 371 Date: Feb. 5, 2018

(30) Foreign Application Priority Data
Jan. 27, 2016 (UA) A201600658

(51) Int. Cl. A47J 37/04; A47J 43/18; A47J 33/00

(52) U.S. Cl. CPC A47J 37/041; A47J 37/049; A47J 33/00; A47J 37/047; A47J 43/18

(57) ABSTRACT

The invention relates to food industry and may be applied as a device for heat treatment of food products. The claimed barbecue spit comprises bearing rod and at least one reinforcing frame on which a grill net is fixed; the latter is configured to keep the product during the rotation of a barbecue spit. A grill net is made of separate meshed elements placed on both sides of a reinforcing frame, at least one meshed element is bended outward. The invention allows to design a barbecue spit of an extended length and with high cooking performance and versatility of cooked products.

### TECHNICAL FIELD

The invention relates to food industry and may be applied as a device for heat treatment of food products. In particular, the invention relates to devices for cooking meals by heat treatment with the ability to hold meal while cooking and to change permanently or periodically its position relative to the heat source by rotation. The present invention covers the main advantages of both roasting spits and grill nets, and is intended both to cook food of one type and to cook simultaneously a plurality of different meals over an open fire or charcoal flame, as well as with a help of the heat emitted by electrical devices. The application of this invention is of particular interest for restaurants, food outlets, for catering of mass events, culinary shows.

### DEFINITIONS

In the sense of the present invention, it is understood that the term barbecue spit relates to a long, resistant to deformation device for holding and cooking meals with a help of heat treatment by permanent or periodic rotation or by their rotation within a particular sector. A barbecue spit comprises a bearing rod and at least one rod reinforcing frame or at least one reinforcing frame configured to be connected/disconnected with another frame and a rod. In particular, in the sense of the present invention a spit covers such concepts as a skewer, a needle, a spike and a barbecue grill net or a broil rack. A characteristic feature of such term as a “spit” in the sense of this invention is its considerable length and the ability to increase significantly a length of a barbecue spit.

In the sense of this invention the distinctive feature of a barbecue spit is a spit reinforcing frame being its integral part. The intended purpose of a reinforcing frame is to prevent deformation of a bearing rod of a spit and, as a result, to provide the greatest possible length of a spit. Whereas a frame may be performed as one solid element with a spit rod and—in preferred embodiment—as a frame separated from other spit elements. Another purpose of a reinforcing frame is that a frame is the basis for holding meal inside it with the help of the grill net while a roasting spit is turning.

A grill net is a meshed structure made of any durable and heat-resistant materials designed to hold the food within a reinforcing frame. A grill net may be a wire mesh formed by interweaving, welding and/or other coupling of elongated elements such as wires and/or rods and/or bands, etc. The main requirement to a grill net is the ability to hold meals within a reinforcing frame of a barbecue spit and the availability of space between net elements to ensure free pass of heat emitted from the source. In addition to connected and/or interweaving of elongated elements, a grill net can be made of perforated parent sheets.

In the sense of the present technical solution, such term as “fastening elements” refers to device for fixing a grill net within a reinforcing frame of a barbecue spit, not limited to a specific embodiment. One of the preferred embodiments for fastening elements that has excellent functionality and benefits from advantages of its design is a bracket fastening with a pin.

A bracket connection with a pin is a special embodiment of fastening elements for fixing grill nets within a spit frame allowing to secure and/or adjust the inner volume of rack formed by spit's meshed elements by fixing pins in the holes. These holes provide specified degree of pressure of meshed elements and frame to each other and/or ensure specified volume of rack formed by spit's meshed elements.

The length of a barbecue spit is a distinctive term of the present invention which underlines that according to the invention a barbecue spit maintains its operational capacity at such length at which the traditional spit rod becomes unusable due to deformations.

### PRIOR ART

The prior art knows devices for cooking dishes on the open fire or over hot charcoal flame or another source of heat by impaling small pieces of food or tiny products on fine metal or wooden spikes which are usually known as skewers or spits. Such devices are suitable for quick cooking of small amounts of food intended for one or two persons. In such case a set of such spikes is needed to cook larger amount of food because this device is designed to hold limited amount of food due to its low structural strength, which can result in sagging. Another aspect is that cooking with spikes is limited to a specific type of food to be roasted because of lack of opportunity to fix the product on a spike, which leads to deformation and scrolling of a piece(s) of the product and its inability to roast evenly. Because of a great length a cook must look after the position of products, ensure that they are in the middle of a spike and prevent a spike from slipping to one side.

A patent for utility model UA 83718 U dated Sep. 25, 2013 discloses a design of a spike with variable and/or extended length. However, certain problems typical for conventional skewers of different cross-sections were revealed during their operation, namely: insufficient fixation of certain products such as poultry, fish, vegetables, mushrooms, seafood on a skewer; inability to use the device for cooking meals which because of its nature can not be impaled on a spike, i.e. corncobs, soft vegetables such as tomatoes, etc; the process of using the claimed device is too complicated due to the need to prepare semi-finished products in advance and to impale them on a skewer.

To ensure greater productivity in roasting large pieces of food the device known as a barbecue spit is used. Barbecue spit's most common designs are usually provided with means to fix the meals, which are usually secured on a spit and have the parts partially impaled into a meal. In other embodiments, the fixation means are clamping strips or holding grids, executed as shown, for example, in the webpage: http://www.amazon.co.uk/Stainless-Steel-Rotisserie-Basket-Holder/dp/B00P6S3IQO

However, known barbecue spits have the same major drawbacks as spikes and skewers when the higher cooking performance is needed. In addition, cooking with a traditional spike requires considerable time, certain skills and experience of the chef.

Another one device for cooking over an open fire is a grill net. These devices, especially when they comprise a closing meshed element, have significant advantages over skewers and spits primarily due to simplicity of use and variety of products, both in form and structural features, that can be prepared with this device.

Another advantage of grill nets is that they are usually made of relatively thin wires, providing ease of manipulating with it while cooking and transportation; these wires allow to process completely the surface of the product directly from an open fire or heat, not from a contact with hot metal, ensure aesthetics of food and reduce the cost of a grill net.

Despite of the advantageous application of wires to configure grill nets, such configuration has its disadvantages that occur in situations when one needs to prepare meals for a large number of people. A size of grill net is limited due to its low strength. When increasing a size of grill nets and applying significant load on them, they start to deform due to sagging like skewers and spits. Also when turning or rotating structures made of large and especially extended meshes they also undergo torsional deformation to correct which considerable time and a master with certain skills are required making this procedure irrational. Even if the grill nets are handled carefully during cooking and the appropriate jacks or supports are used, the long wires or rods of a grill net will be still vulnerable because of their length and warping in result of thermal stresses. This is due to possible irregular temperature of a fire or a heat, which happens quite often, and uneven heating of the wires or rods of a grill net due to the contact with a cooked meal, that remains relatively cold during grilling because of evaporated moisture, on its certain sections and higher warmup of others sections without the meal.

Another invention that is useful for understanding the subject of the claimed invention is a device for heat treatment of food over fire disclosed in the patent specification GR 1007915 B dated Jun. 10, 2013. The device has a meshed part and supporting part. This device is not suited to significant extending. Without solid support individual grill net rods will lose their stability when extending and will be vulnerable to all the negative factors inherent in the common grill nets. GR 1007915 attempts to increase the strength of a grill net by increasing a thickness of net rods, but this way is considered structurally inefficient because not all elements of the mesh undergo the same load. As a result, such design is considered to be inefficient due to low strength/weight ratio. In addition there is no possibility to interconnect several devices of this kind in the longitudinal structure of considerable length in reliable and functionally efficient way. Also this design does not allow adjusting interior space between the grill nets that significantly reduces functionality of the device.

Because of these disadvantages a big number of grill nets and/or skewers and/or spits is needed to satisfy a large and diverse demand in grilled dishes. Usually this option is not efficient because it requires to attract “many hands” or to use specialized expensive equipment. Experience has shown that less personnel is needed to operate one large device than to work with many small ones for making the same amount of food. The prior art virtually does not know attempts to create a reliable grill accessory designed for servicing mass events. The Chinese utility model disclosed in CN 203524514 U dated Apr. 9, 2014 shows an attempt to create a sectional barbeque grill of a large size with the ability to rotate. The analysis of the proposed model showed some advantages over its analogs known in the prior art. However its described design allows to use only several sections of grill nets. Further attempts to increase their number failed due to defects inherent in the closest prior art.

Another idea for grill accessories with which manufacturers tried to improve or diversify grill devices and which may be of interest to understand the nature and advantages of the present invention is reflected in devices wherein a grill net and a barbecue spit are combined. Such technical solutions are known particularly from the following patent publications: US 2014338545 A1 dated Nov. 20, 2014, US 2014338545 A1 dated Nov. 20, 2014, CN 203576321 A1 dated Jul. 5, 2014. In the analyzed patents a spit is used as a bearing element and a device on which a grill basket is mounted. A spit holds the baskets and/or turns them to a heat source, spit's bearing rod reduces the load on the grill net but because of this it suffers the higher load. Despite certain advantages, such devices cannot be used or scaled for mass production due to the disadvantages of the prior art described above. Publication CN 203576321 A1 is cited among the chosen technical solutions as the closest analogue.

### SUMMARY OF THE INVENTION

The invention is based on the task to create a high-performance device, which must be capable of simultaneous cooking a large number of different products. The device must be suitable for frying the required volumes determined by the need of any real situation. In most cases, the option of productivity expansion must be implemented when necessary, while allowing to cook the barbecue products of various types and forms. An important condition of solving the problem should be the reliability and simplicity of the device used.

The problem is solved by a barbecue spit designed according to the present invention, which consists of a bearing rod and a grill net. A characteristic design feature of the proposed device is that a bearing rod is reinforced by at least one reinforcing frame (hereinafter—a frame) on which a grill net is fixed; the latter is configured to keep the product during the rotation of a barbecue spit.

The claimed device is suitable for cooking a variety of foods including those which may be cooked by traditional impaling on a spit rod and those which cannot be hold on a barbecue spit by means of impaling.

The design of the claimed device provides for the use of a barbecue spit as a continuous extended structure and allows further strengthening of a barbecue spit bearing rod by adding the additional frames to it to form an even longer structure, which can be up to several meters long. Such a design is ensured by a total structural strength of a bearing rod and the reinforcing frames.

Despite the fact that the claimed roasting spit is designed for mass production of grilled foods and provides for much larger dimensions than known analogs, subject to compliance with structural features as described in the patent claims, it can be scaled to any size determined by the practical needs.

### DETAILED DESCRIPTION OF THE INVENTION

The main design disadvantage of the prior art devices is the inability to use them for simultaneous cooking of a large number of grilled products due to deformation caused by loading and warping of device elements caused by uneven thermal influence. Elimination of hardware deformations is usually achieved by appropriate selection of a more durable material and/or by structure reinforcement with heavier parts or additional elements, such as reinforcement ribs, fillets, strainers or spacers.

For such a device as a classic barbecue spit, including its main part, i.e. a bearing rod, such techniques are not applicable because the use of expensive materials for its manufacturing is usually unjustified and ineffective, the increase of the rod thickness or material buildup in certain areas makes it difficult and in some cases even impossible to impale the products thereon, leads to unaesthetic appearance of a rod itself and a cooked product, and complicates its maintenance.

Nevertheless, the presented solution managed not only to use the known engineering method to strengthen a rod of a barbecue spit but also to make a design for it with an additional targeted useful feature, therefore extending perspectives of its application.

The proposed technical solution involves strengthening of a rod not simply by its thickening in some areas, but also by reinforcement of these areas with the frames. A frame is considered to be a reinforcing frame if it eliminates the bearing rod deflection, which leads to the slipping of a barbecue spit to one side.

Practical application of a known principle for a particular embodiment has provided an unexpected result in a particular engineering field, having determined new technical advantages for the proposed device.

The constructive benefit from a frame with such configuration is also that the frame, depending on the tasks, can be upgraded to ensure higher strength. Because a frame is not intended for stringing, various known methods to reinforce its structure can be used. In particular they relate to its cross-sectional shape, configuration of its reinforcement ribs, the use of composite materials for making the whole frame or its parts. Another easy way to increase the strength of a frame is to increase its massiveness. The main condition is that the frame should be of sufficient strength to eliminate the rod deflection to ensure its wide use and the possibility to mount a grill net on it capable of holding the products thereto. This allows to create a more extended and efficient device.

Bearing rod outside the frame also becomes more resistant to deformation, since a frame forms a kind of bearing for it reducing the imaginary shoulder with which the weight of a structure and products placed into it causes bending of a bearing rod.

When it comes to the barbecue spit design represented by a rod with a frame reinforcing the same, the concept of the presented invention provides that the rod does not necessarily have to be extended inside the reinforcing frame, although this embodiment provides for the greatest strength and length of a barbecue spit. For better use of internal space formed by the frame, the rod may not pass through the central part. However, such embodiment does not eliminate or replace distinctive features defined by the patent claims. In this case, the distinctive feature of a “bearing rod” refers to an embodiment of at least a part of the rod in the U-shaped form known in the prior art (see http://www.amazon.co.uk/Stainless-Steel-Rotisserie-Basket-Holder/dp/B00P6S3IQO referred above). In this case, the term “reinforcing frame” shall mean also a frame designed as a U-shaped frame, which is mounted symmetrically opposite the relevant part, forming an unoccupied useful space to place the products.

One of the preferred embodiments of a barbecue spit provides for making both a detaching bearing rod and a detaching frame, allowing to add new additional components to a barbecue spit or a frame, to form a more extended spit and to increase the productivity of the cooking process. In a preferred embodiment, the number of frames on a rod is 2 to 10, and the length of a barbecue spit is, preferably, 0.2 to 5 m, and the width is 0.05 to 0.6 m.

A frame can be made of any rolled steel section, which will ensure structural strength of a frame and a barbecue spit in general. However, in practice, there may be some important points to be taken into account in the design, related to the ease of device maintenance. In the preferred embodiment of a claimed barbecue spit, a square steel rod was chosen as a source material; the hollow square section can also be used. This is one of the strongest sections, and, importantly, this strength is the same in all loading directions. The square section is suitable for storage, stacking, transportation, easy to wash, polish, and repair. The square section can easily be used to design a barbecue spit, to fix a grill net and fasteners on its flat surface. For more easy process of connecting individual parts of a barbecue spit, better retention of the impaled products, the bearing rod should be made with a square cross-section. It will further prevent the impaled products and assembled parts from scrolling relative to each other. When the square section of the rod bearing is used, its flat surface can be used as a support area. Thus, when a barbecue spit is rotated by 90 or 180°, it can be fixed for some time in an appropriate position on a flat support without the use of fixing tools, which simplifies the device operation significantly. A bearing rod of a barbecue spit made of a square section provides an additional advantage that is the ability to grill the foods on four sides one by one. A square rod or a square hollow section of a barbecue spit bearing rod allows fixing the barbecue spit in four positions, which is sufficient to prepare uniformly grilled, ruddy product, and can easily be handled by one person. The proposed embodiment eliminates the need for continuous even turning when cooking on a barbecue spit which requires special equipment or tedious, monotonous manual rotation and eliminates the inherent weakness of a grill net upon manual maintenance, i.e. roasting on two sides only.

As noted above, a frame in the form of the presented design solution is not only a reinforcing design element, but it is also used to hold the product within the same grill net designed for cooking mainly while cooking. The term “while cooking” implies that a grill net holds the food within the internal space formed by grill nets during rotation and does not allow them to shift or fall out from this space.

A grill net can be made of any type or design, provided that its structure will ensure retention of products within its scope. For the purposes of the present invention, two variants will be acceptable. They are a grill basket, which is symmetrically mounted on the frame with a side configured to open, and the grill nets made of separate elements placed on both sides of the reinforcing frame. The last embodiment of this design solution is more preferred, because it provides more options for mounting and allows to vary the internal volume. To reduce the grill net warping due to thermal stress, some parts of a grill net can be made shorter than the frame length, but they must be located in the butt to each other and attached to the frame.

Grill nets are preferably made of wires or rods held together by any method suitable for this invention. The preferable cross-section of wires or rods is 0.5 to 3 mm. Also, a grill net can be made of wires or rods of different thicknesses to reduce the thermal stress and reinforce the grill net design. Typically, the longitudinal components are thicker, and the cross-sectional ones are thinner. In a preferred embodiment, the cross-section of wires or rods of various sections is chosen in the interval of 0.5 to 3 mm.

In another embodiment, the grill net can be made by perforating the blank sheet, and the perforated section can occupy 30 to 90% of the parent sheet area. In a preferred embodiment, the thickness of the perforated parent sheet is chosen within 0.5 to 3 mm.

The grill nets are attached to each other and/or to the frame by any known means, for example, by elastic bending of the frames formed by insertion in grooves made on the frame using the hooks or by pin connections. The basic requirement for these connections is reliable attachment and fast locking/unlocking.

The preferred embodiment of the present invention uses a mounting bracket with a pin, holding the grill net within the frame by elastic pressing of the holding meshed elements of a grill net to the frame. This lock is made using a W-shaped bracket with a hole in the central end or a U-shaped bracket with the holes in the side ends into which the pin is inserted, securing the grill net and the bracket within the frame. Additional advantage of a bracket connection is that both W- and U-shaped brackets can be used as a support for the grill net in which the dish can be offered to the table, if the restaurant's image supposes such serving.

The next fastening element is a hook with bended ends. The distance between the hook ends is the same as the distance between the grill nets. After a meal is placed into a grill net, it is pressed, forming an elastic tension, and thus fixed with a hook.

The next fastening element is a screw fastening made of a pin with one bended end and threads on the other. The process of fixation is similar to previous embodiments with the difference that this lock is fixed with a fly nut.

The last embodiment of the lock is more reliable but less quick and easy to fix. These types of fastening elements meet all requirements established for them, namely holding reliability and locking/unlocking speed. The number of connections within a grill net may vary from 1 to any desired. The other clamps and clothespins known in the prior art and suitable for the design can be used for the purposes of the present invention.

Another possible embodiment of the presented device is, for example, when one of the meshed elements of a grill net is firmly attached to a frame, and the other is made so that it may be opened, but not detached. An embodiment when both sides of the grill net can only be opened, but not detached, may be useful in certain cases.

As noted earlier, a variety of fastening options for the grill net detachable parts allows to change the internal volume formed by the grill nets for better product retention therein, which prevents the separate pieces of products from rolling and forming a pile during rotation and prevents damage of delicate products. At least one part of the holding grill net with a bending allows to adjust inner space between the grill nets. If both sides of one holding grill net of a single frame are detachable, such a barbecue spit allows arranging three different volumes by placing one or both grill nets with a bend inside or outside. The proposed design of a barbecue spit also allows adjusting the volume formed by the grill nets by gapping attachment of the frame parts to a barbecue spit frame. When it is required to cook a dish which size exceeds the inner space volume formed by grill nets upon their tight attachment to the frame (such as ribs, knuckle, or pumpkin) the grill nets can be attached within the frame to form the required space. This attachment can be accomplished with a pin with one bended end and a thread with a fly nut on the other end, hook mount of the relevant size and a bracket connection with a W- or U-shaped bracket with a pin. Then the meshed elements of a grill net are attached to each other using one or more types of these fasteners, securing an oversized product into the inner space and formating an appropriate gap between the grill net parts and a frame. To eliminate the possible movements, the grill net with the dish can be additionally locked to the parts of a barbecue spit by any method suitable for a particular situation. Also, a barbecue spit can be operated with an opportunity of certain movement of grill nets with dishes within the frame, unless it causes the product damage or obvious discomfort in operation.

A barbecue spit may have one or more frames to ensure different volumes for different meal products. Meanwhile, when one product is ready, it can be removed, and another one will still be cooked.

The preferable material for a holding grill net and a frame is stainless steel, since this material proved to be the most viable in the course of development and ensures the best value for money. However, the experts know that not only stainless steel can be selected as a material for device manufacturing according to this invention, but also any other metal suitable for this purpose and ensuring the appropriate specifications. The parts of a barbecue spit can be made of one or more materials selected from the group of iron alloys, steel, stainless steel, titanium, titanium alloys, composite and/or ceramic materials.

The presented device is intended to grill various products. It is a universal extendable device for mass cooking, when one needs to roast a large amount of food. Another advantage of the proposed barbecue spit is that it allows to roast the whole parts, such as animal carcasses, which greatly simplifies the organizational aspects of supply and utilization of raw materials, because it allows simultaneous cooking of the parts which may be cooked by conventional impaling and the foods which cannot be hold on a barbecue spit by impaling with a bearing rod.

Due to sectional structure and significant length of a barbecue spit, there is an opportunity to expand or adjust the proposed range of roasted products depending on the cooking needs. The example of such products is fish and poultry meat, which, because of its structure and small density, is badly impaled on a barbecue spit leading to undesirable rotation or loss of the products as a result of falling from a barbecue spit. However fish and poultry meat is roasted perfectly in the holding grill nets.

Also, the claimed barbecue spit design allows to cook the other products, which may be cooked over an open fire or heat, and which cannot be impaled on a barbecue spit, such as kebab, schnitzel and any products made of minced meat. The special advantage of a barbecue spit can be demonstrated by the fact that the proposed device allows rotating a large number of food products intended for roasting, such as chops for burgers, in one movement.

In normal situations, when one person fries burger chops, one shall place them onto the hot surface, then turn them to the other side and remove one by one. When cooking chops for burgers using a claimed barbecue spit, twenty chops and more can be fried over fire simultaneously and they can be turned to the other side with one movement. The proposed device ensures additional quality of products, because there is no need to turn the food, infringing its integrity and appearance. All products can be turned over simultaneously, eliminating the delay factor due to sluggishness, forgetfulness, inattention, or unforeseen circumstances. Cooking eliminates the human factor as much as possible, especially when it comes to cooking for a large number of consumers. When, for example, a barbecue spit with four frames is used, it allows placing eighty burger chops to the grill simultaneously. The grill operator, by turning a barbecue spit instead of burger chops can turn all eighty chops to the other side in a second. A barbecue, e.g. UA 83718 U, allows placing three barbecue spits containing 80 burger chops each, simultaneously. In this case, all 240 burgers are placed over fire or heating source almost simultaneously, and an experienced grill operator is able to turn over all 240 burger chops with one movement in a few seconds.

The claimed barbecue spit also showed an excellent performance while cooking peppers, eggplants, zucchinis, tomatoes, potatoes, corncobs, and fine seafood. The design of the claimed barbecue spit and its main advantages are shown in the following figures.

### LIST OF FIGURES

FIG. 1—general view of an assembled barbecue spit according to the invention with enlarged images D and E.

FIG. 2—view of a spit frame.

FIG. 3—preferred embodiment of a spit's grill net fixed with W-shaped bracket with a pin.

FIG. 3a—a pin of a grill net fastener

FIG. 3b—W-shaped bracket of a grill net fastener

FIG. 4—a holding grill net with enlarged image F.

FIG. 5—an embodiment of spit's end with a detachable connection

### DESCRIPTION OF FIGURES

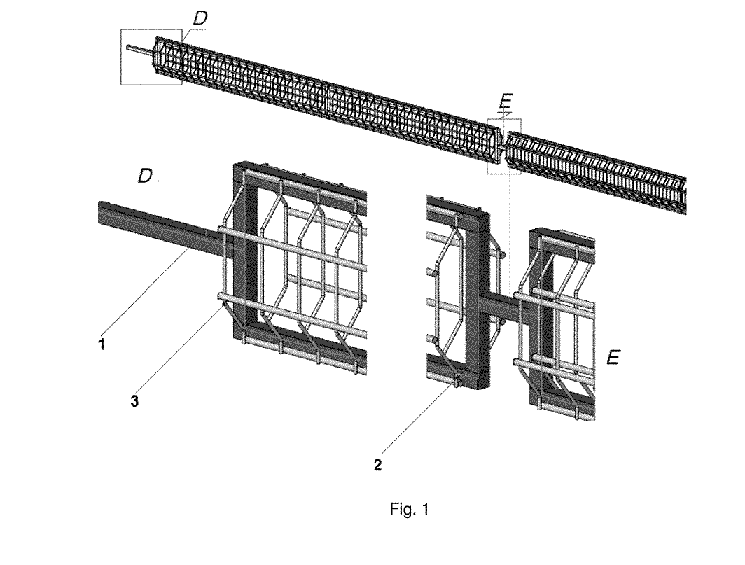

FIG. 1 shows one of the possible embodiments for a barbecue spit. There are enlarged images D and E which show structural specifics of a barbecue spit. FIG. 1 shows that a barbecue spit structurally consists of a bearing rod (1) enforced with the frames (2). Outer end edges of a rod are supporting elements however they can be used for impaling food. The parts of bearing rod can be supplemented with additional bearing intervals. The holding grill nets (3) are fixed within a frame (2).

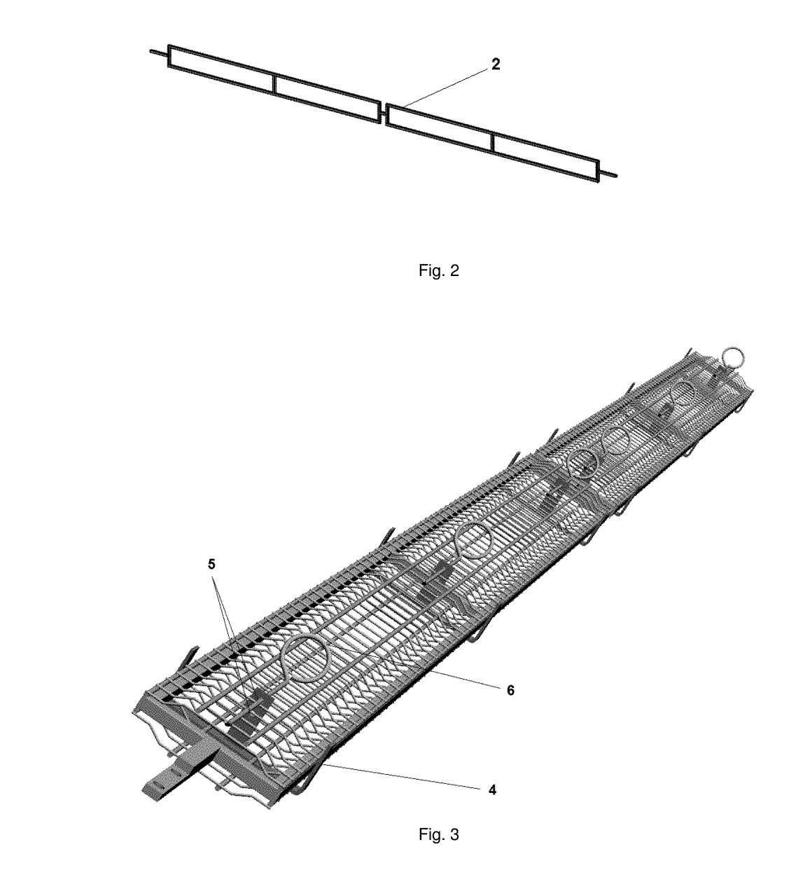

FIG. 2 depicts one possible embodiment of a barbecue spit (1) with two reinforcing frames (2). The presented design can be performed as a solid and demountable structure. To facilitate the operation each frame has an additional cross-connection element, which is optional but useful, especially with a barbecue spit of a large length.

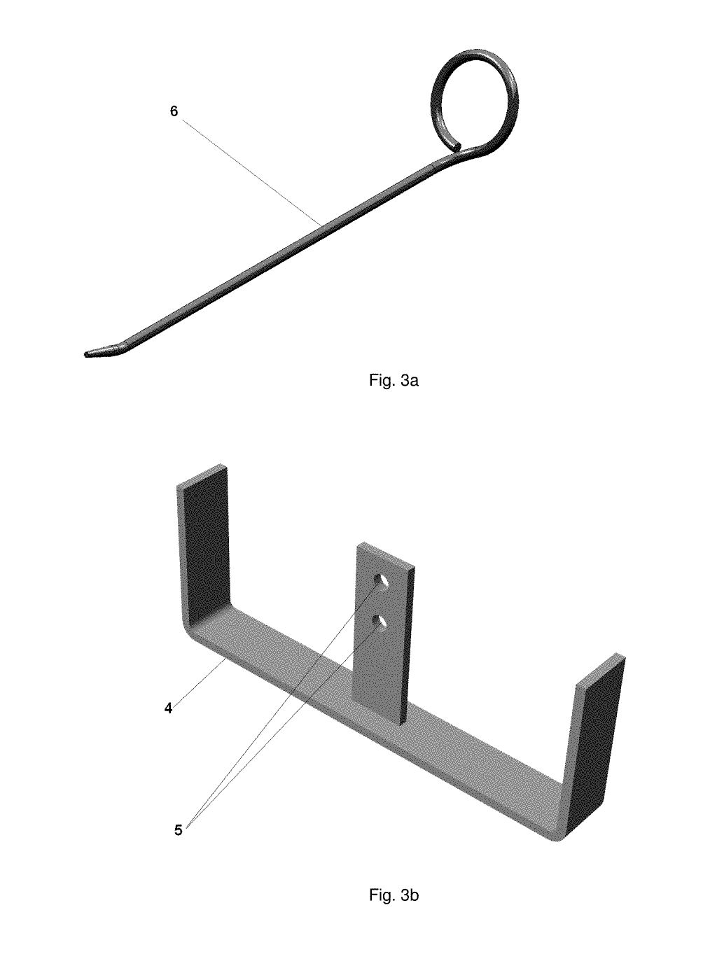

FIG. 3 shows a preferred embodiment of the fastening elements for the grill nets. The fastening elements hold a grill net within the frame by pressing of the meshed elements of a grill net to a frame and by additional locking of meshed elements within a frame. This fastening elements are configured as W-shaped brackets (4) (hereinafter—the bracket) with a hole (5) in a central end. With its inner part, a bracket (4) holds one part of the grill net, while its central end passes through wires or rods of a grill net. Then a part of a grill net (3) with a bracket is connected to a reinforcing frame (2) so that the side ends of this bracket embrace this frame. The other part of a grill net is mounted onto the other side of a reinforcing frame (2) so that it passes between the side ends of a bracket whereas a central end of a bracket passed through its wires or rods. A pin (6) is inserted into a hole made in a central end, which projects over a grill net. The parts of a grill net (3) fixed by means of such fastening elements are securely fixed onto a frame. To ensure reliable fastening, diameter of a bracket hole should correspond to diameter of a pin (6). Also it is preferable that a length and a shape of a pin are the same as shown in FIG. 3 and FIG. 3a. According to a preferred embodiment, a bracket is configured so as to adjust the degree of pressure and, sometimes, the inner volume of a rack formed by the meshed elements of a grill net. To ensure this, a number of holes (5) are made in a central end of a bracket (4). For example, if a degree of pressure is insufficient, it can be increased by inserting a pin (6) in the next suitable hole (5). Even if a degree of pressure is appropriate it can be increased to reduce the inner volume inside the rack to a certain degree by parallel reducing the possibility of moving for food inside.

Another advantage of configuring fasteners as a W-shaped bracket (4) with a pin (5) is that with a series of holes made in a central end of a bracket (4) we can not only reduce the inner volume, which is determined by position of meshed elements of a grill net and the degree of pressing them together, but also to increase volume to a certain degree if necessary. For this purpose it is proposed to use a bracket (4) with elongated ends and, consequently, with more holes (5), made in its central projection. In the event when it is necessary to prepare a meal which size does not allow to fix it inside a rack, formed by meshed elements of a grill net (3), fastening is done by inserting a pin (6) in the next suitable hole (5) of elongated central projection of a bracket (4). In this case, a sufficient degree of pressing a meal to the elements of a grill net (3) is ensured and a meal is fixed with a help of the brackets (4) with the pins (6). Thus it is possible to achieve the required degree of pressing a meal to the meshed elements of the grill net (3), to form an acceptable gap between the elements of the grid (3) and a frame (2), and achieve even greater versatility of a barbecue spit (1) with respect to a variety of products that can be cooked simultaneously in it.

FIG. 3a shows one of the embodiments for a pin which is considered to be the most advantageous for functional design of bracket connection. A pin (6) is made of any suitable material. One of its ends is narrowed to facilitate its entering into a bracket hole. For this purpose this pin end can be bended to a certain degree. The other end of a pin is bended to make manipulations with pin more easy while locking and unlocking. This bend may be made by a simple bending of a pin end at a certain angle or it is made in a shape of a hook or any other suitable shape. In a FIG. 3a this bend is made in a shape of an eye. This embodiment is the most convenient and safe. It facilitates maintenance and transportation of pins. Pins can be kept in suspended state. A connection can be unlocked quickly and safely due to the easer removal of a pin by means of hooking an eye with special and available equipment.

FIG. 3b shows in more details configuration of a W-shaped bracket (4) for a preferred embodiment of grill nets fastening. Similar to a pin, a bracket can be made of any suitable material. There are several holes (5) in its central end to provide specified degree of pressure of meshed elements and frame to each other and/or ensure specified volume of rack formed by spit's meshed elements as it was described above. FIG. 3b shows two holes (5) in a central end, but it is clear that the number of holes and the length of a bracket end can be either, depending on the requirements of real situations. In addition to the direct functioning as a connection element a bracket can be used as a support for the grill net in which the dish can be offered to the table. In this case it can be further configured using various design techniques. Of course, it must be ensured that all technical and operational characteristics of a bracket are preserved.

According to the alternative embodiment, the fastening can be configured with the help of U-shaped bracket. The idea of fastening is the same as for a W-shaped bracket with the only difference that this bracket has no central end and a pin is inserted not in the longitudinal direction with relation to a spit—into a hole in a central end as in the previous embodiment—but in a transverse direction—in a symmetrical pair of holes made in side ends of an U-shaped bracket. At the same time the idea of adjusting a degree of pressure for grill net elements is the same. In addition this embodiment of fastening elements is more advantageous because there is no need to configure an element for securing a grill net on a frame. This causes obvious advantages to operate a barbecue spit such as convenient washing, cleaning, repairing, storing, etc.

Another advantage of this type of a lock is that it can be easily disassembled, which is important when dealing with hot equipment. A person can demount the device even without using his hands, for example, with a help of a “key” which is inserted into eye of pin to pull it out. In addition, during disassembling all cooked meals remain on the grill net and can be served directly on grill net and put on a support to the customers, which is especially important for keeping shape of “delicate” products and/or for creating a special mood of serving procedure. Especially it can be demonstrated in the case of using securing W-shaped or U-shaped brackets as supports.

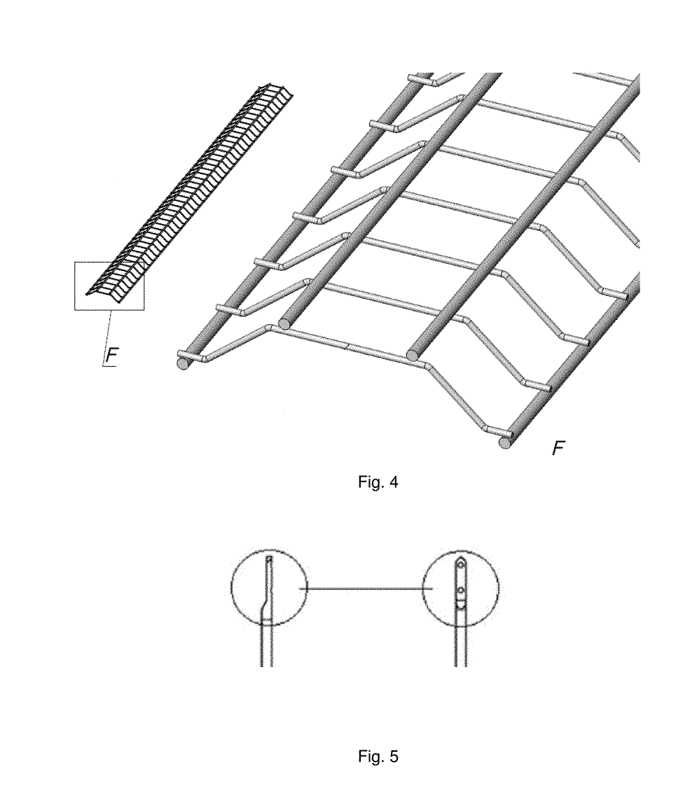

FIG. 4 shows a part of a holding grill net (3) separated from a frame (2) of a spit (1) with an enlarged image F. The proposed shape is most preferable for the present invention because it allows to adjust the volume of the internal space in the rack by fixing a bended side of a grill net both inside and outside the frame.

FIG. 5 shows one possible embodiment for spit's ends which are configured as sharp elements of assembling pair for screw/bolt or pin connections and can be used for direct impaling of meal products subject to cooking.

The present device operates as follows. The products that are subject to cooking are placed on one of the meshed parts of a grill net that occupies the lower position on the frame of assembled spit or on the separate meshed part of a grill net if it is not rigidly connected with a frame. Products to be grilled on a spit are strung on a bearing rod or its parts that will be connected with the frames or its other parts. The parts of a holding grill net that need to be fixed are secured on the frame to form a closed rack for food products. A position of a bended part of a grill net to be connected to the frame—outward or inward position—is determined on the assumption that if this will prevent the free movement of products in the rack formed by a grill net or not. This condition is quite advantageous. Additional adjustment of volume formed by a grill net is possible by means of locks, which allow to adjust the degree of pressure of the parts of a grill net to the frame. The parts of a holding grill net are fixed in a manner appropriate to a special case. A bracket connection for the parts of a grill net that is chosen as a preferred embodiment of the present invention but not limiting hereto, is disclosed in the description to the FIG. 3.

An assembled spit is moved to a heat source. An open fire or a hot charcoal flame can be used as a source of heat in a barbecue for example as disclosed in patent UA 83718 U. After cooking, in one case, a spit is moved from heat source and put in the side tray, an upper part of a holding grill net is removed and the cooked product is taken out. In other case, for example, when we deal with the removable frames, the upper fastening elements of a grill net are removed after placing an accessory like the spade under the lower part of a grill net. In this case the cooked meal remains in the lower part of a grill net and can be served in it for eating or put into other containers or dishes.

The claimed invention can be illustrated with the following examples. Example 1. A barbecue spit with a rack, main embodiment.

A barbecue spit consists of a bearing rod (1) with two rectangular frames (2). A length of a spit is 2.5 meters. The design of a barbecue spit provides two disassembling frames in a rectangular shape made of metal wire of square cross-section with a thickness of 7 mm and a length of 1.2 m, width of 10 cm connected together with a segment of metal rod of the same cross-section and a length of 5 cm. On the outer edges of the frame there are also the segments of sharpened rod with a length of 10 cm. A frame may be provided with a transverse cross-bar which helps to suspend a spit or to place it on the supporting items of a barbecue or the supports installed on the ground that facilitates spit's assembling and disassembling, or to eliminate other unforeseen situations.

Grill net parts are connected to the frames and due to outward bended structure form a rack for food to be cooked. The grill nets are made of a thin wire with cross-section of 1 and 2 mm. The grill net rods intersect at right angles and are fixed by welding. The preferable width of the grill net is 5-10 mm less than the width of the outer frame width, that helps to regulate the space between the grill nets.

The space between the parts of grill nets is adjusted to fit different sizes of products placed inside in the following way. According to the first variant, a bended part of a grill net is put outside, while according to the second variant one of a bended parts of the grill net is placed inside a rack to reduce the space between the grill nets.

The grill nets are fixed freely on a frame and after products are placed between them the grill nets are fixed with the brackets with a pin or with a hook which pull together two grill nets with some tension. Due to such tension the grill nets are secured to the frame.

A barbecue spit in an assembled state and filled with products is placed on a barbecue with glowing coals. A grill operator looks after the degree of heating and roasting of a product by changing the position of the grill to 90°. As the product is heated, the number of rotations of a spit should increase gradually for even roasting and acquiring attractive brown surface.

A square cross-section of a bearing rod eliminates the need for monotonous turning of a spit and/or the need to apply any mechanical means for fixing it in a specified position when some side of product needs additional roasting over a heat. When a grill operator finds that the product is prepared, the parts of a grill net with prepared product are removed from a spit and are replaced with the new ones with a new product or the frames with grill nets are removed and replaced by new frames with grill nets with a new product, or they are replaced with a rod section with impaled products or the whole spit is taken to a separate tray and is used according to the situation.

Example 2. A barbecue spit, alternative embodiment. According to another embodiment of the invention a bearing rod (1) and a reinforcing frame (2) are configured the same way as in the example 1. It differs from the main embodiment only in that a grill net is solidly secured to the frame with one side that allows to open/close the other unsecured side. This side is fixed to the frame with the help of a bracket.

Another feature of the implementation is that a spit is equipped with the additional reading rod sections on its sides and inside for extra impaling of suitable product onto it. Further process of cooking and spit operation is similar to the one described in the Example 1.

Example 3. A spit, another alternative embodiment. According to a further embodiment, a bearing rod (1) and a reinforcing frame (2) are configured the same as in the Example 1, with the difference that a grill net is made of pieces of perforated sheet metal with the thickness of 1 mm.

The area of evenly spaced holes on a grill net configured this way covers more than 50% of the total area of the sheet material. The space between the parts of a grill net and the grill net fastening elements is adjusted in a similar way as described in the Example 1.

The invention has the following technical results: An extended barbecue spit with a grill net, designed according to this invention, ensures high cooking performance and versatility of food products to be cooked with its use;

The proposed device can be scaled to any size by serial connection of the frames and the bearing rods to each other; The device has a universal design, which is achieved by the possibility to connect the various elements between each other; frames of different shapes and capacities can be combined in one design, and in addition the traditional spit rods can be combined in one device.

Such design of a spit provides quick operation and low complexity of the process of placing products on the spit and removal of products and the possibility to use it in combination with effective means of fastening, including brackets with pins;

There is no need to keep a large number of small devices in the kitchen or kitchen area such as skewers, grills; the cooking process is more organized; A larger number of products can be grilled evenly without the need to involve special equipment for rotating or turning, work of a grill operator is much simplified. The device reduces the number of service staff per unit of manufactured products;

The number of spoiled ready-to-serve dishes due to human factor is reduced; The ready-to-serve dishes can be served to the consumers directly in spit elements, such as the grill nets; The invention ensures reliable fixation of products inside the rack meshes that prevents products from falling out and/or from uneven cooking;

The invention provides uniform roasting over an open fire of such products as fish meat, whole fish, seafood, vegetables and others; The invention provides possibility to rotate simultaneously a large number of small products for example 80 burger chops in less than a second while grilling; The device insures intensification and mobility of a cooking process without compromising quality. For example, a team of 6 people, under the supervision of an experienced cook, can deploy a food service unit within two hours and prepare a wide range of dishes, including at least four kinds of dishes (meat, vegetables, potatoes and bread products, such as khachapuri) and feed about two thousand people, and then close and remove a food service unit.

1. (canceled)

2. (canceled)

3. (canceled)

4. (canceled)

5. (canceled)

6. (canceled)

7. (canceled)

8. (canceled)

9. (canceled) claim 10. (canceled) claim 11. (canceled) claim 12. (canceled) claim 13. (canceled) claim 14. (canceled) claim 15. (canceled) claim 16. (canceled) claim 17. (canceled) claim 18. (canceled) claim 19. (canceled) claim 20. (canceled)

21. A barbecue spit comprising;
a bearing rod and a holding grill net additionally comprising reinforcing frames, wherein the reinforcing frames are interconnected by a fragment of the bearing rod, wherein the reinforcing frames and the bearing rod are made of same section, wherein the reinforcing frames and the bearing rod are configured to connect with additional one or more of the reinforcing frames and/or fragments of the bearing rod while the holding grill net is placed on both sides of at least one reinforcing frame and forming space to keep a product within the reinforcing frame during cooking.

22. The barbecue spit according to claim 21 wherein the holding grill net is made of separate elements of the holding grill net placed on both sides of the reinforcing frame.

23. The barbecue spit according to claim 21 wherein the separate elements of a holding grill net are configured to be detached freely from a reinforcing frame.

24. The barbecue spit according to claim 21 characterized in that one of the separate elements of a holding grill is firmly attached to one side of a reinforcing frame, and the other, on another side, is made so that it may be opened and closed but not detached.

25. The barbecue spit according to claim 21 characterized in that separate elements of a holding grill on the both sides of a frame are made so that they may be opened and closed but not detached.

26. The barbecue spit according to claim 21 wherein it has 2 to 10 reinforcing frames.

27. The barbecue spit according to claim 21 wherein the length of a barbecue spit is 0.2 to 5 m.

28. The barbecue spit according to claim 21 wherein the width of a holding grill net is 0.05 to 0.6 m.

29. The barbecue spit according to claim 21 wherein one or two separate elements of a holding grill net may have an outward bend.

30. The barbecue spit according to claim 21 wherein at least one separate element of a holding grill net is bended inside a rack.

31. The barbecue spit according to claim 21 wherein its parts are made of one or more materials selected from the group of iron alloys, steel, stainless steel, titanium, titanium alloys, composite and/or ceramic materials.

32. The barbecue spit according to claim 21 wherein the holding grill net is made of wires or rods with cross-sections of 0.5 to 3 mm.

33. The barbecue spit according to claim 21 wherein the holding grill net is made of wires or rods of two or more cross-sections chosen in the interval of 0.5 to 3 mm.

34. The barbecue spit according to claim 21 wherein the holding grill net is made by perforating the blank sheet, and the perforated section occupies from 30 to 90% of the parent sheet area.

35. The barbecue spit according to claim 21 wherein the holding grill nets are fixed within a frame with a mounting bracket with a pin.

36. The barbecue spit according to claim 21 wherein the bracket is configured as a W-shaped bracket with a series of holes made in the central end to secure a pin in one hole which will ensure a specified degree of pressure between holding grill nets and reinforcing frame and it will ensure specified volume of rack formed by holding grill nets.

37. The barbecue spit according to claim 36 wherein the bracket is configured as a U-shaped bracket with a series of symmetrical holes made in the side ends to secure a pin in one pair of symmetrical holes which will ensure a specified degree of pressure between holding grill nets and reinforcing frame and it will ensure specified volume of rack formed by holding grill nets.

38. The barbecue spit according to claim 21 wherein the holding grill nets are secured within a frame with a help of one or several fixing elements such as a hook, a pin with a hook on one end and a curved thread and a fly nut on the other end.

39. The barbecue spit according to claim 21 wherein the reinforcing frame and a bearing rod are made of a square-shaped rod or a hollow square section.
